(19) United States
(12) Patent Application Publication
(10) Pub. No.: US 2018/0307218 A1
(43) Pub. Date: Oct. 25, 2018

(54) SYSTEM AND METHOD FOR ALLOCATING MACHINE BEHAVIORAL MODELS

(71) Applicant: Presenso, Ltd., Haifa (IL)

(72) Inventor: David LAVID BEN LULU, Nesher (IL)

(73) Assignee: Presenso, Ltd., Haifa (IL)

(21) Appl. No.: 16/020,335

(22) Filed: Jun. 27, 2018

Related U.S. Application Data
(63) Continuation of application No. PCT/US2017/012833, filed on Jan. 10, 2017.
(60) Provisional application No. 62/280,151, filed on Jan. 19, 2016.

(51) Int. Cl. G05B 23/02; G06F 17/30; G06F 15/18; G06N 5/00

(52) U.S. Cl. CPC G05B 23/0218; G06N 5/003; G06F 15/18; G06F 17/30979

(57) ABSTRACT

A system and method for allocating machine behavioral models. The method includes analyzing, via unsupervised machine learning, a plurality of sensory inputs associated with a machine, wherein the unsupervised machine learning outputs at least one normal behavior pattern of the machine; selecting, based on the output at least one normal behavior pattern, at least one machine behavioral model; generating, based on the selected at least one machine behavioral model, an optimal machine behavioral model representing behavior of the machine; and allocating the generated optimal machine behavioral model to the machine.

### CROSS-REFERENCE TO RELATED APPLICATIONS

This application is a continuation of International Application No. PCT/US2017/012833 filed Jan. 10, 2017 which claims the benefit of U.S. Provisional Application No. 62/280,151 filed on Jan. 19, 2016, the contents of which are hereby incorporated by reference.

### TECHNICAL FIELD

The present disclosure relates generally to maintenance systems for machines, and more specifically to allocating models representing machine behavior.

### BACKGROUND

Communications, processing, cloud computing, artificial intelligence, and other computerized technologies have advanced significantly in recent years, heralding in new fields of technology and production. Further, many of the industrial technologies employed since or before the 1970s are still used today. Existing solutions related to these industrial technologies have typically seen minor improvements, thereby increasing production and yield only slightly.

In modern manufacturing practices, manufacturers must often meet strict production timelines and provide flawless or nearly flawless production quality. As a result, these manufacturers risk heavy losses whenever an unexpected machine failure occurs. A machine failure is an event that occurs when a machine deviates from correct service. Errors, which are typically deviations from the correct state of the machine, are not necessarily failures, but may lead to and indicate potential future failures. Besides failures, errors may otherwise cause unusual machine behavior that may affect performance.

The average failure-based machine downtime for typical manufacturers (i.e., the average amount of time in which production shuts down, either in part or in whole, due to machine failure) is 17 days per year, i.e., 17 days of lost production and, hence revenue. In the case of a typical 450 megawatt power turbine, for example, a single day of downtime can cost a manufacturer over $3 million US in lost revenue. Such downtime may have additional costs related to repair, safety precautions, and the like.

In energy power plants, billions of US dollars are spent annually on ensuring reliability.

Specifically, billions of dollars are spent on backup systems and redundancies utilized to minimize production downtimes. Additionally, monitoring systems may be utilized to identify failures quickly, thereby speeding up the return to production when downtime occurs. However, existing monitoring systems typically identify failures only after or immediately before downtime begins.

Further, existing solutions for monitoring machine failures typically rely on a set of predetermined rules for each machine. These rules sets do not account for all data that may be collected with respect to the machine, and may only be used for checking particular key parameters while ignoring the rest. Moreover, these rules sets must be provided in advance by engineers or other human analysts. As a result, only some of the collected data may be actually used by existing solutions, thereby resulting in wasted use of computing resources related to transmission, storage, and processing of unused data. Further, failure to consider all relevant data may result in missed or otherwise inaccurate determination of failures.

Additionally, existing solutions often rely on periodic testing at predetermined intervals. Thus, even existing solutions that can predict failures in advance typically return requests to perform machine maintenance even when the machine is not in immediate danger of failing. Such premature replacement results in wasted materials and expenses spent replacing parts that are still functioning properly. Further, such existing solutions often determine failures only after failure occurs. As a result, such failures may not be prevented, resulting in down time and lost revenue.

Further, existing monitoring and maintenance solutions often require dedicated testing equipment. Consequently, these solutions typically require specialized operators who are well-trained in the operation of each monitoring and maintenance system. Requiring specialized operators can be inconvenient and costly, and may introduce potential sources of human error. Additionally, given the sheer amount of data that may be collected for any given machine in addition to minute fluctuations in data, a human analyst is not capable of adequately determining upcoming failures.

Moreover, existing solutions for monitoring machine performance are typically configured to only monitor particular types of machines and/or sensors. As a result, such existing monitoring solutions cannot be utilized for other types of machines and sensors. Further, any changes to a machine and/or its sensors (e.g., replacing a machine with a different type of machine, replacing an engine of a machine with a different engine, etc.) may result in inaccurate monitoring using such existing solutions.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for allocating machine behavioral models. The method comprises: analyzing, via unsupervised machine learning, a plurality of sensory inputs associated with a machine, wherein the unsupervised machine learning outputs at least one normal behavior pattern of the machine; selecting, based on the output at least one normal behavior pattern, at least one machine behavioral model; generating, based on the selected at least one machine behavioral model, an optimal machine behavioral model representing behavior of the machine; and allocating the generated optimal machine behavioral model to the machine.

Certain embodiments disclosed herein also include a non-transitory computer readable medium having stored thereon instructions for causing a processing circuitry to perform a process, the process comprising: analyzing, via unsupervised machine learning, a plurality of sensory inputs associated with a machine, wherein the unsupervised machine learning outputs at least one normal behavior pattern of the machine; selecting, based on the output at least one normal behavior pattern, at least one machine behavioral model; generating, based on the selected at least one machine behavioral model, an optimal machine behavioral model representing behavior of the machine; and allocating the generated optimal machine behavioral model to the machine.

Certain embodiments disclosed herein also include a system for allocating machine behavioral models. The system comprises: a processing circuitry; and a memory, the memory containing instructions that, when executed by the processing circuitry, configure the system to: a processing circuitry; and a memory, the memory containing instructions that, when executed by the processing circuitry, configure the system to: analyze, via unsupervised machine learning, a plurality of sensory inputs associated with a machine, wherein the unsupervised machine learning outputs at least one normal behavior pattern of the machine; select, based on the output at least one normal behavior pattern, at least one machine behavioral model; generate, based on the selected at least one machine behavioral model, an optimal machine behavioral model representing behavior of the machine; and allocate the generated optimal machine behavioral model to the machine.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a model allocator system according to an embodiment.

FIGS. 3A and 3B are simulations illustrating modeling of sensory inputs.

FIG. 4 is a simulation illustrating a general model of a plurality of meta-models.

FIG. 5 is a flowchart illustrating a method for allocating a machine behavioral model according to an embodiment.

FIG. 6 is a flowchart illustrating a method for generating an optimal machine behavioral model according to an embodiment.

FIG. 7 is a simulation illustrating a machine behavioral model representing a normal operation of a machine.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for allocating machine behavioral models. In an embodiment, sensory inputs associated with a machine or a component of a machine are analyzed via unsupervised machine learning to determine normal behavioral patterns of the machine or component. Based on the normal behavioral patterns, at least one machine behavioral model for representing operations of the machine or component is selected. An optimal machine behavioral model for the machine or component is generated based on the selected at least one machine behavior model and allocated to the machine or component for purposes of machine monitoring.

The analysis may further include modeling the sensory inputs and detecting indicators in the sensory inputs. The modeling may include generating meta-models for each component or portion of the machine. The meta-models are monitored to detect indicators therein. Based on the indicators, machine behavior patterns of the components may be determined. The machine behavioral models may be selected based on the machine behavior patterns.

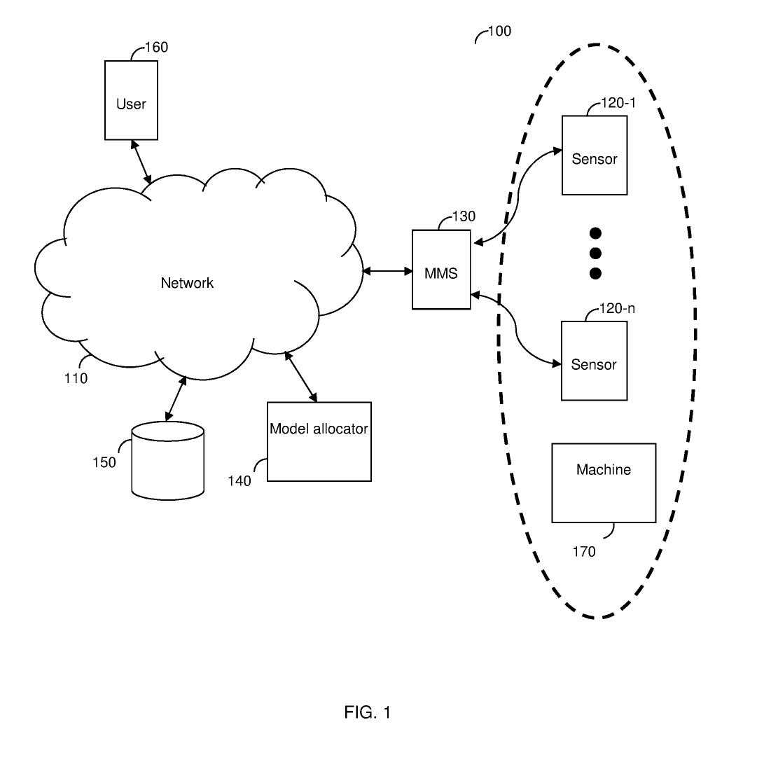

FIG. 1 shows an example network diagram 100 utilized to describe the various disclosed embodiments. The example network diagram 100 includes a machine monitoring system (MMS) 130, a model allocator 140, a database 150, and a client device 160 communicatively connected via a network 110. The example network diagram 100 further includes a plurality of sensors 120-1 through 120-n (hereinafter referred to individually as a sensor 120 and collectively as sensors 120, merely for simplicity purposes), communicatively connected to the machine monitoring system 130. The network 110 may be, but is not limited to, a wireless, a cellular or wired network, a local area network (LAN), a wide area network (WAN), a metro area network (MAN), the Internet, the worldwide web (WWW), similar networks, and any combination thereof.

The client device 160 may be, but is not limited to, a personal computer, a laptop, a tablet computer, a smartphone, a wearable computing device, or any other device capable of receiving and displaying notifications indicating maintenance and failure timing predictions, results of unsupervised analysis of machine operation data, or both.

The sensors 120 are located in proximity (e.g., physical proximity) to a machine 170. The machine 170 may be any machine for which performance can be represented via sensory data such as, but not limited to, a turbine, an engine, a welding machine, a three-dimensional (3D) printer, an injection molding machine, a combination thereof, a portion thereof, and the like. Each sensor 120 is configured to collect sensory inputs such as, but not limited to, sound signals, ultrasound signals, light, movement tracking indicators, temperature, energy consumption indicators, and the like based on operation of the machine 170. The sensors 120 may include, but are not limited to, sound capturing sensors, motion tracking sensors, energy consumption meters, temperature meters, and the like. Any of the sensors 120 may be, but are not necessarily, communicatively or otherwise connected to the machine 170 (such connection is not illustrated in FIG. 1 merely for the sake of simplicity and without limitation on the disclosed embodiments).

The sensors 120 may be in proximity to the machine 170 if, e.g., each sensor 120 is within a predetermined threshold distance from the machine or otherwise deployed such that the sensor can capture sensory signals related to machine operation. As a non-limiting example, a sound sensor 120-4 may be proximate to the machine 170 if the sound sensor 120-4 is close enough to the machine 170 to capture sounds with at most a threshold amount of noise, distortion, or both.

The sensors 120 are communicatively connected to the machine monitoring system 130. The machine monitoring system 130 may be configured to store and to preprocess sensory inputs received from the sensors 120. Alternatively or collectively, the machine monitoring system 130 may be configured to periodically retrieve collected sensory inputs stored in, for example, the database 150. The preprocessing may include, but is not limited to, timestamping sensory inputs, de-trending, rescaling, noise filtering, a combination thereof, and the like.

The preprocessing may further include feature extraction. The results of the feature extraction may include features to be utilized by the model allocator 140 during unsupervised machine learning in order to detect indicators. The feature extraction may include, but is not limited to, dimension reduction techniques such as, but not limited to, singular value decompositions, discrete Fourier transformations, discrete wavelet transformations, line segment methods, or a combination thereof. When such dimension reduction techniques are utilized, the preprocessing may result in, e.g., a lower-dimensional space for the sensory inputs. The machine monitoring system 130 is configured to send the preprocessed sensory inputs to the model allocator 140.

In an embodiment, the model allocator 140 is configured to receive, via the network 110, the preprocessed sensory inputs associated with the machine 170 from the machine monitoring system 130. The sensory inputs may be received continuously, and may be received in real-time.

In an embodiment, the model allocator 140 may further store the sensory input data received from the machine monitoring system 130. Alternatively or collectively, the sensory input data may be stored in the database 150. The database 150 may further store sensory inputs (raw, preprocessed, or both) collected from a plurality of other sensors (not shown) associated with other machines (also not shown). The database 150 may further store indicators, anomalous patterns, failure predictions, behavioral models utilized for analyzing sensory input data, or a combination thereof.

In an embodiment, the model allocator 140 is configured to analyze the preprocessed sensory inputs. The analysis may include, but is not limited to, unsupervised machine learning. In a further embodiment, the unsupervised machine learning may include one or more signal processing techniques, implementation of one or more neural networks, or both. It should be noted that different parameters represented by the sensory inputs may be analyzed using different machine learning techniques. For example, a temperature parameter may be analyzed by applying a first machine learning technique to sensory inputs from a temperature sensor, and an energy consumption parameter may be analyzed by applying a second machine learning technique to sensory inputs from an energy consumption gage.

In an embodiment, the model allocator 140 may be configured to automatically select at least one optimal method for detecting indicators in the sensory input data based on, e.g., a type of one or more portions of the data. In a further embodiment, the selection may be based on results from applying a plurality of models to each at least a portion of the sensory input data. In yet a further embodiment, the selection may be based further on a number of false positives in the results.

In a further embodiment, the model allocator 140 is configured to generate a meta-model based on at least one portion of the machine 170. Each portion of the machine for which a meta-model is generated may be a component (not shown) such as, but not limited to, a pipe, an engine, a portion of an engine, a combination thereof, and the like. Generating a meta-model may include, but is not limited to, selecting a model that optimally indicates anomalies in the sensory inputs for each of the at least one portion of the machine 170. Each of the generated meta-models is utilized to detect anomalies in the behavior of the respective portion of the machine 170.

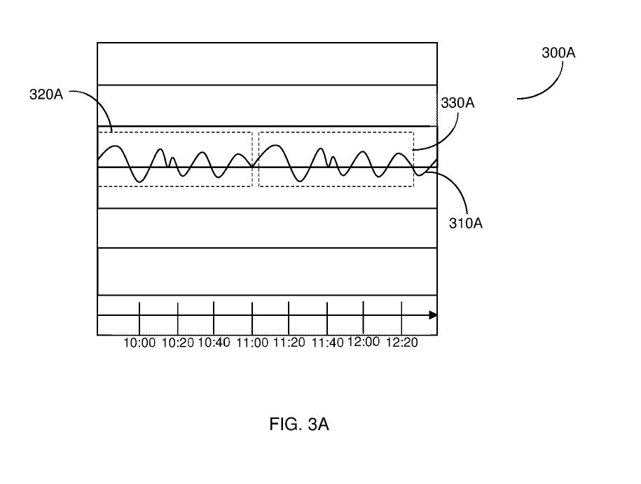

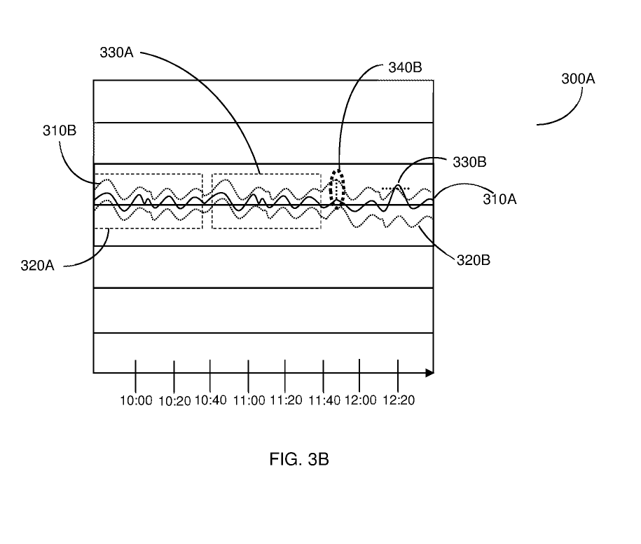

In an embodiment, the model allocator 140 is configured to generate, in real-time, at least one adaptive threshold for detecting anomalies based on the analysis. In a further embodiment, the model allocator 140 is configured to determine, in real-time, normal behavior patterns for the sensory inputs of the machine 170 or each portion thereof. The adaptive thresholds may be generated based on the determined normal behavior patterns. Each adaptive threshold is a threshold utilized to determine anomalies that may change over time in accordance with the normal behavior patterns. As a non-limiting example, the adaptive threshold may increase and decrease proportionally to increases and decreases in the normal behavior patterns, respectively. Generation of adaptive thresholds for detecting anomalies based on normal behavior patterns is described further herein below with respect to FIGS. 3A and 3B.

In an embodiment, based on the normal behavior patterns of the machine 170, the model allocator 140 is configured to allocate machine behavioral models to the machine 170. The allocated models may be utilized for, e.g., monitoring of the machine 170 using unsupervised machine learning. The monitoring may be further used to, e.g., detect anomalies, predict failures, determine root causes of failures, combinations thereof, and the like.

In an embodiment, the model allocator 140 may be configured to obtain sensory inputs captured by the sensors 120 and to analyze, via unsupervised machine learning, the obtained sensory inputs to determine normal behavior patterns of the machine 170. In a further embodiment, based on the determined normal behavior patterns, the model allocator is configured to select one or more machine behavioral models from among a plurality of machine behavioral models stored in, e.g., the database 150. Based on the selected machine behavioral models, the model allocator 140 is configured to generate an optimal machine behavioral model. The model allocator 140 is further configured to allocate the generated optimal machine behavioral model to the machine 170 with respect to the machine monitoring system 130. The machine monitoring system 130 may be configured to monitor behavior of the machine 170 using the allocated optimal machine behavioral model.

It should be noted that the machine monitoring system 130 is shown in FIG. 1 as a separate component from the model allocator 140 merely for simplicity purposes and without limitation on the disclosed embodiments. The machine monitoring system 130 may be incorporated in the model allocator 140 so as to allow the model allocator 140 to obtain and preprocess sensory inputs without departing from the scope of the disclosure.

It should also be noted that the embodiments described herein above with respect to FIG. 1 are discussed with respect to a user device 160 and a machine 170 merely for simplicity purposes and without limitation on the disclosed embodiments. Multiple user devices may receive information related to machine maintenance and failures without departing from the scope of the disclosure. Additionally, sensory inputs related to multiple machines may be collected to determine normal behavior patterns of any or all of the machines without departing from the scope of the disclosure.

It should be further noted that the embodiments disclosed herein are not limited to the specific architecture illustrated in FIG. 1 and that other architectures may be equally used without departing from the scope of the disclosed embodiments. Specifically, the model allocator 140 may reside in the cloud computing platform, a datacenter, on premise, and the like. Moreover, in an embodiment, there may be a plurality of model allocators operating as described hereinabove and configured to either have one as a standby proxy to take control in a case of failure, to share the load between them, or to split the functions between them.

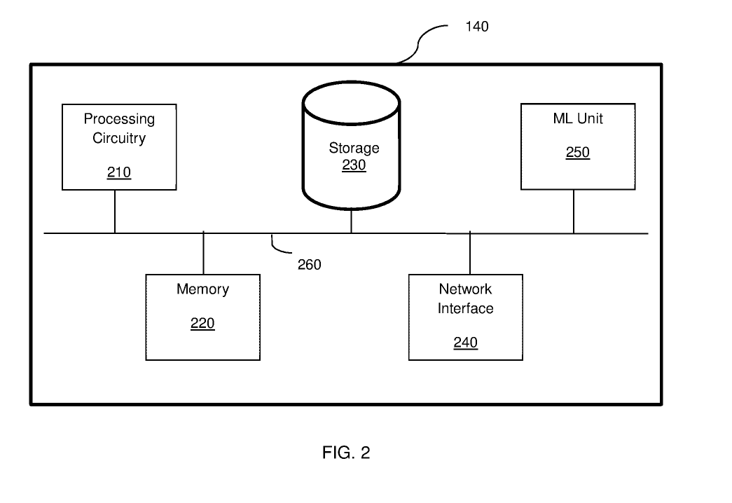

FIG. 2 shows an example block diagram of the model allocator 140 implemented according to an embodiment. The model allocator 140 includes a processing circuitry 210 coupled to a memory 220, a storage 230, a network interface 240, and a machine learning (ML) unit 250. In an embodiment, the components of the model allocator 140 may be communicatively connected via a bus 260.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to perform predictions of machine maintenance as described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the model allocator 140 to communicate with the machine monitoring system 130 for the purpose of, for example, receiving preprocessed sensory inputs. Additionally, the network interface 240 allows the model allocator 140 to communicate with the user device 160 in order to send, e.g., notifications related to anomalous activity.

The machine learning unit 250 is configured to perform unsupervised machine learning based on sensory inputs received via the network interface 240 as described further herein. In an embodiment, the machine learning unit 250 is further configured to determine, based on the unsupervised machine learning, normal behavior patterns for machines. The normal behavior patterns may be used to allocate machine behavioral models as described herein.

It should be understood that the embodiments described herein are not limited to the specific architecture illustrated in FIG. 2, and other architectures may be equally used without departing from the scope of the disclosed embodiments.

FIG. 3A is an example simulation illustrating determining machine behavioral patterns. The simulation shown in FIG. 3A includes a graph 300A in which sensory inputs associated with a machine are represented by a curve 310A. In the example simulation shown in FIG. 3, the curve 310A represents an aggregated behavior of the sensory inputs over time. During operation of a machine (e.g., the machine 170, FIG. 1), the aggregated behavior represented by the curve 310A may be continuously monitored for repeated sequences such as repeated sequences 320A and 330A. Upon determination of, for example, the repeated sequence 320A, the repeated sequence 330A, or both, a model of a normal behavior pattern of the machine is generated. It should be noted that continuous monitoring of, e.g., two or more cycles of behavior may be useful for determining more accurate patterns. As monitoring and, consequently, learning, continue, the normal behavior model may be updated accordingly. The models of normal behavior patterns may be utilized to allocate behavioral models for monitoring machine operations. As a non-limiting example, machine behavioral models including patterns that are similar to the repeated sequences 320A and 330A may be selected and utilized to generate an optimal model for representing operations of the machine.

FIG. 3B is an example simulation 300B illustrating generation of adaptive thresholds. Based on one or more repeated sequences (e.g., the repeated sequences 320A and 330A), a maximum threshold 310B and a minimum threshold 320B are determined. The thresholds 310B and 320B may be determined in real-time and regardless of past machine behavior. In an example implementation, the thresholds 310B and 320B are dynamic and adapted based on the sequences 320A and 330A as well as any subsequently determined sequences. The point 330B represents an indicator of anomalous behavior, i.e., a data point that is above the maximum threshold 310B or below the minimum threshold 320B. Upon determination that one of the thresholds 310B or 320B has been exceeded, an anomaly may be detected. Thus, the thresholds 310B and 320B represent upper and lower bounds, respectively, of normal behavior for the machine.

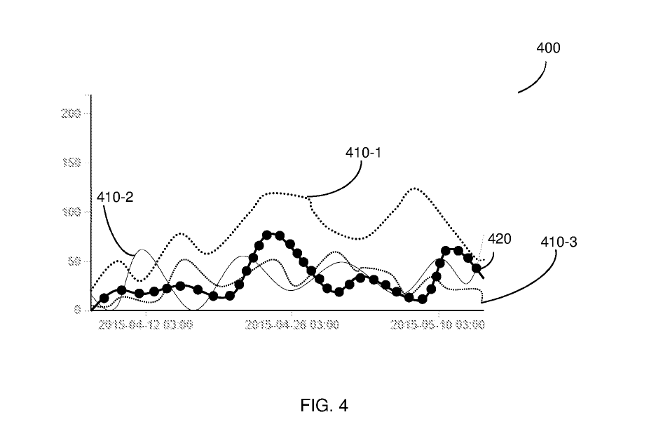

FIG. 4 is an example simulation 400 illustrating generating a behavioral model of a machine based on a plurality of meta-models. In the example simulation 400, a machine (e.g., the machine 170) including three components is being monitored, where the three components are represented by the meta-models 410-1, 410-2, and 410-3, respectively. The meta-models are based on sensory inputs related to their respective components, and may be utilized to identify anomalies in the operation of each respective component of the machine. Based on the meta-models 410-1 through 410-3, a model 420 that is an optimal representation of the machine may be generated.

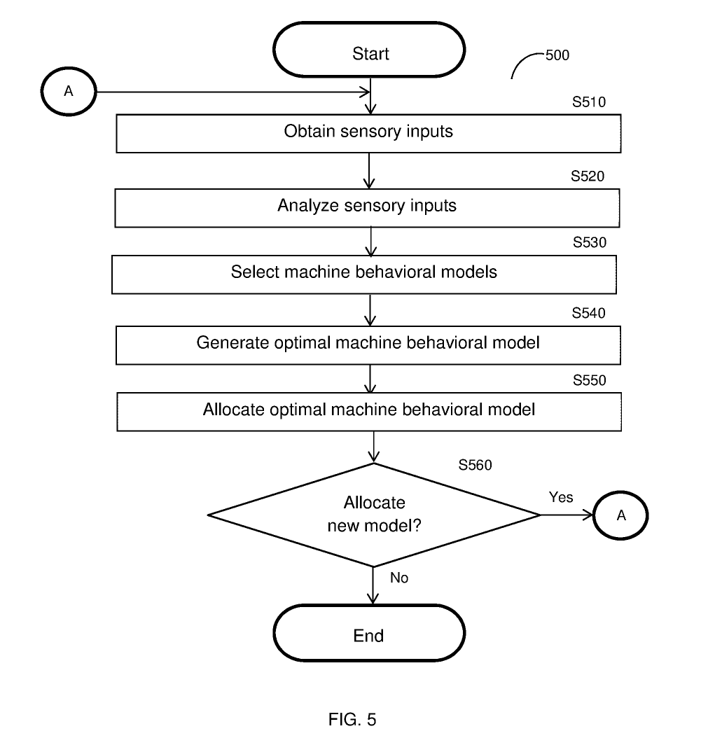

FIG. 5 is an example flowchart 500 illustrating a method for allocating a machine behavioral model to a machine according to an embodiment. In an embodiment, the method may be performed by the model allocator 140.

At S510, a plurality of sensory inputs associated with a machine are obtained. The associated sensory inputs may be or may be based on, but are not limited to, sensory signals captured by sensors that are proximate (e.g., physically proximate) to the machine. Such sensors may be proximate to a machine if, e.g., each sensor is within a predetermined threshold distance from the machine or otherwise deployed such that the sensor can capture sensory signals related to machine operation. As an example, a sound sensor may be proximate to the machine if the sound sensor is close enough to the machine to capture sounds with at most a threshold amount of noise, distortion, or both. The obtained sensory inputs may be received from, e.g., the sensors that are in proximity to the machine, or may be retrieved from, e.g., a storage. In an embodiment, S510 may include continuously receiving, in real-time, the plurality of sensory inputs.

In an embodiment, the obtained sensory inputs are preprocessed. The preprocessed sensory inputs include features to be utilized as inputs for unsupervised machine learning. The preprocessed sensory inputs may be robust to noise and distortions.

In another embodiment, the obtained sensory inputs may be received or retrieved as raw sensory data. In a further embodiment, S510 may include preprocessing the raw data. In yet a further embodiment, S510 may further include retrieving raw sensory data, and extracting features from the raw sensory data. The extracted features may include, but are not limited to, a reduced-dimension subset of the raw sensory data. In another embodiment, S510 may further include de-trending, rescaling, noise filtering, or a combination thereof.

At S520, the sensory inputs are analyzed to determine at least one normal behavior pattern. The analysis includes, but is not limited to, unsupervised machine learning using the preprocessed sensory inputs. The outputs of the unsupervised machine learning process include the at least one normal behavior pattern.

In an embodiment, the unsupervised machine learning may include one or more signal processing techniques, implementation of one or more neural networks, or both. In a further embodiment, sets of sensory inputs including different parameters (e.g., sound parameters, energy consumption parameters, motion parameters, temperature parameters, etc.) may be analyzed using different machine learning techniques.

In a further embodiment, S520 also includes generating at least one adaptive threshold based on the at least one normal behavior pattern. The adaptive thresholds may be utilized to, e.g., determine whether data deviates from the at least one normal behavior pattern. Each adaptive threshold is a threshold with values of the threshold that are different at, e.g., different times. Thus, the adaptive thresholds may represent, for example, upper bounds, lower bounds, or both, of normal machine behavior and may be used to determine whether at least some sensory inputs are anomalies. As a non-limiting example, an adaptive threshold may represent a lower bound of non-anomalous data such that a sensory input below the value of the adaptive threshold at a given time is determined to be an anomaly. Example adaptive thresholds are described further herein above with respect to FIG. 3B.

At S530, based on the determined normal behavior patterns, at least one machine behavioral model is selected. The selected machine behavioral models may be selected from among a plurality of predetermined machine behavioral models stored in, e.g., at least one database. To this end, S530 may include, but is not limited to, searching through or querying at least one database storing machine behavioral models based on the determined normal behavior patterns. The selected machine behavioral models collectively represent normal behavior of the machine during operation.

At S540, an optimal machine behavioral model representing operations of the machine is generated. The optimal machine behavioral model may be utilized during machine monitoring to detect anomalies in operation of the machine. To this end, the optimal machine behavioral model may be utilized as a model during unsupervised machine learning using sensory inputs associated with the machine to output anomalies. In an embodiment, the optimal machine behavioral model may be utilized to detect all anomalies occurring during operation of the machine.

In another embodiment, if it is determined that one of the selected machine behavioral models matches the output machine behavior patterns above a predetermined optimal model threshold, S540 may include selecting the matching machine behavioral model for use as the optimal machine behavioral model.

At S550, the optimal machine behavioral model is allocated to the machine. In an embodiment, S550 may include, but is not limited to, sending the optimal machine behavioral model to a machine monitoring system (e.g., the machine monitoring system 130, FIG. 1) for use during monitoring using unsupervised machine learning to detect anomalies. The monitoring may further allow for generation of analytics for operation of the machine related to, e.g., irregular peaks, anomalies, trends, energy consumption parameters, and the like.

At S560, it is determined whether a new machine behavioral model should be allocated and, if so, execution continues with S510; otherwise, execution terminates. The determination of whether to allocate a new machine behavioral model may be made in real-time based on one or more reallocation rules. The one or more reallocation rules may be based on, but are not limited to, passage of a predetermined amount of time (e.g., one week), collection of a predetermined amount of data since last allocation, receipt of a request to update the machine behavioral model (e.g., from a user device of an operator or supervisor of the machine), and the like. The reallocation may be based on at least a portion of data collected during a given time period. As a non-limiting example, the reallocation rules may require that the machine behavioral model be reallocated monthly using sensory input data collected during a particular week in the previous month.

Reallocating machine behavioral models allows for dynamically and adaptively changing the machine behavioral model used for the machine over time. Such a dynamic model improves machine monitoring by ensuring that the most optimal model for the machine is used at any given time. Machine behavioral models may become less optimal over time as, e.g., the machine ages (i.e., due to use), parts or components of the machine are replaced, environmental factors affecting operation of the machine change (e.g., if the machine is moved to a colder environment in which machine performance is different), a combination thereof, and the like.

As a non-limiting example, a plurality of sensory inputs associated with a plastic injection molding machine are received from sensors in proximity to (e.g., within 3 feet of) the machine. The sensory inputs include motion signals, sound signals, and energy signals. The received sensory inputs are analyzed, via unsupervised machine learning, where the output of the unsupervised machine learning includes normal behavior patterns of the plastic injection molding machine. Based on the output normal behavior models, a database storing predetermined machine behavioral models is searched to determine at least one machine behavioral model that matches the output normal behavior patterns above a predetermined threshold. Machine behavioral models for a motion sensor, a sound sensor, and an energy sensor of a glass injection molding machine are selected based on similarities between the selected models and the output normal behavior patterns. Based on the selected machine behavioral models, an optimal machine behavioral model is generated for the plastic injection molding machine.

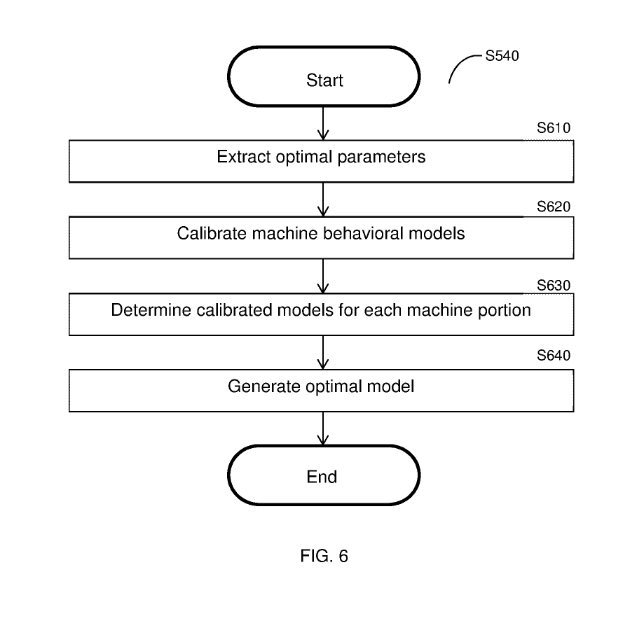

FIG. 6 is an example flowchart S540 illustrating a method for generating an optimal machine behavioral model according to an embodiment. In an embodiment, the optimal machine behavioral model is generated based on a plurality of machine behavioral models (e.g., the machine behavioral models selected at S530, FIG. 5) and a plurality of sensory inputs associated with a machine (e.g., the sensory inputs obtained at S510, FIG. 5).

At S610, for each machine behavioral model, at least one optimal parameter is extracted from the plurality of sensory inputs. The optimal parameters are values for a model that most optimally represent normal behavior of the machine with respect to the model and, therefore, can be utilized to most accurately detect anomalies in machine behavior when using the model. Specifically, the optimal parameters, when input to the model, produce an output that most optimally represents normal machine behavior with respect to the machine behaviors represented by the model. The at least one optimal parameter may include one or more sensory inputs, one or more groups of sensory inputs, or both. The at least one optimal parameter may include sensory inputs of one or more types (e.g., sound, motion, temperature, energy, etc.), sensory inputs of one or more sets (e.g., sensory inputs captured during one or more time periods), a combination thereof, and the like.

In an embodiment, S610 may include applying a plurality of heuristics to the sensory inputs with respect to each model. Determining the optimal parameters increases accuracy of machine learning using the models while reducing computing resources due to, e.g., analyzing parameters that have little or no effect on representations of machine behavior. In an example implementation, the heuristics may be applied, for each model, to a set of parameters including a predetermined base set of parameters and a test parameter of a plurality of test parameters. Based on the application of the heuristics, the distribution and convergence of the base set of parameters as well as the effect of the test parameter may be determined. Based on the determined distribution, convergence, test parameter effect, or a combination thereof, a score may be determined for each test parameter. Test parameters having a score above a predetermined threshold may be extracted as optimal parameters for the model.

At S620, the at least one machine behavioral model is calibrated based on the extracted optimal parameters. In an embodiment, S620 includes running the model using the extracted optimal parameters as inputs.

In an embodiment, S620 may further include analyzing each machine behavioral model based on the corresponding extracted optimal parameters for the model. The analysis may include determining model analytics such as, but is not limited to, an error distribution, an accuracy of confidence estimations, an accuracy of probability estimations, or a combination thereof.

At S630, at least one of the calibrated machine behavioral models is determined for each portion (e.g., each component or combination of components) of the machine. The determined calibrated machine behavioral models optimally represent machine behavior with respect to the corresponding portions of the machine. In an embodiment, the calibrated machine behavioral models for each portion are selected based on the model analytics.

In a further embodiment, S630 further includes generating or receiving a score for each model with respect to each of at least one of the components. Generating the scores may include, but are not limited to, running each model with respect to a predetermined set of inputs, where predetermined anomaly outputs are known for the predetermined set of inputs. The model allocated to each component may be the model with the highest score with respect to the component. The scores may be determined based on, but not limited to, weighted values for model accuracy. Such weighted values may be determined based on, e.g., precision measuring, recall measuring, and the like. The precision measurements indicate a proportion of anomalies detected by running the model that are among the predetermined anomalies, and the recall measurements indicate a proportion of the predetermined anomalies that are detected by running the model.

At S640, an optimal machine behavioral model is generated based on the selected machine behavioral models. In an embodiment, S640 includes clustering the selected machine behavioral models. In a further embodiment, the clustering may include, but is not limited to, adding corresponding values of the machine behavioral models for the components, averaging corresponding values of the machine behavioral models for the components, and the like. In another embodiment, the optimal machine behavioral model may be generated based on models of different types of sensory inputs. In a further embodiment, S640 may include normalizing sensory input values of the different types of models.

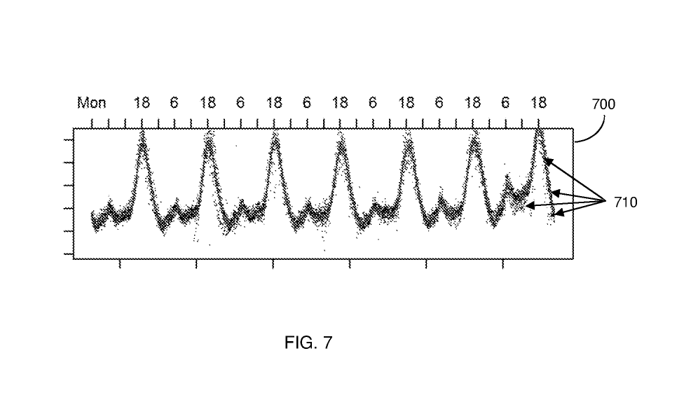

FIG. 7 is an example simulation illustrating a machine behavioral model representing a normal operation of a machine (e.g., the machine 170, FIG. 1). The machine behavioral model seen in FIG. 7 is illustrated via a data plot 700 including a plurality of data points 710. The machine behavioral model may be based on one or more machine behavior patterns (e.g., the repeating sequences 320A and 330A, FIG. 3A). Each data point represents a signal strength (e.g., of a sound, motion, energy, or other signal captured by a sensor) at a particular time. The machine behavioral model of FIG. 7 may be utilized during unsupervised machine learning monitoring of the machine to detect unusual (e.g., anomalous) behavior of the machine during operation.

The machine behavioral model show via the data plot 700 may be an optimal machine behavioral model based on signals such as, but not limited to, sound, motion, energy, combinations thereof, and the like.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for allocating machine behavioral models, comprising:
analyzing, via unsupervised machine learning, a plurality of sensory inputs associated with a machine, wherein the unsupervised machine learning outputs at least one normal behavior pattern of the machine;
selecting, based on the output at least one normal behavior pattern, at least one machine behavioral model;
generating, based on the selected at least one machine behavioral model, an optimal machine behavioral model representing behavior of the machine; and
allocating the generated optimal machine behavioral model to the machine.

2. The method of claim 1, further comprising:
generating, based on the analysis of the plurality of sensory inputs associated with the machine, at least one adaptive threshold for the at least one normal behavior pattern.

3. The method of claim 1, wherein selecting the at least one machine behavioral model further comprises:
querying at least one database for machine behavioral models, wherein each selected machine behavioral model is among a plurality of machine behavioral models returned with respect to the query.

4. The method of claim 1, wherein generating the optimal machine behavioral model further comprises:
clustering at least two of the selected at least one machine behavioral model.

5. The method of claim 4, wherein generating the optimal machine behavioral model further comprises:
extracting, from the plurality of sensory inputs, at least one optimal parameter for each selected machine behavioral model; and
calibrating each selected machine behavioral model based on the at least one optimal parameter extracted for the selected machine behavioral model.

6. The method of claim 5, wherein extracting the at least one optimal parameter for each selected machine behavioral model further comprises:
applying, for the selected behavioral model, a set of heuristics to the plurality of sensory inputs to determine the at least one optimal parameter for the selected machine behavioral model.

7. The method of claim 5, further comprising:
determining, for each portion of the machine, at least one representative model of the calibrated at least one machine behavioral model, wherein the clustered at least two machine behavioral models includes each determined representative model.

8. The method of claim 1, wherein allocating the generated optimal machine behavioral model further comprises sending the generated optimal machine behavioral model to a machine monitoring system, wherein the machine monitoring system monitors behavior of the machine via unsupervised machine learning using the allocated model.

9. The method of claim 1, further comprising:
preprocessing the plurality of sensory inputs, wherein the preprocessing includes extracting at least one feature from raw sensory data.

10. A non-transitory computer readable medium having stored thereon instructions for causing a processing circuitry to perform a process, the process comprising:
analyzing, via unsupervised machine learning, a plurality of sensory inputs associated with a machine, wherein the unsupervised machine learning outputs at least one normal behavior pattern of the machine;
selecting, based on the output at least one normal behavior pattern, at least one machine behavioral model;
generating, based on the selected at least one machine behavioral model, an optimal machine behavioral model representing behavior of the machine; and
allocating the generated optimal machine behavioral model to the machine.

11. A system for unsupervised prediction of machine failures, comprising:
a processing circuitry; and
a memory, the memory containing instructions that, when executed by the processing circuitry, configure the system to:
analyze, via unsupervised machine learning, a plurality of sensory inputs associated with a machine, wherein the unsupervised machine learning outputs at least one normal behavior pattern of the machine;
select, based on the output at least one normal behavior pattern, at least one machine behavioral model;
generate, based on the selected at least one machine behavioral model, an optimal machine behavioral model representing behavior of the machine; and
allocate the generated optimal machine behavioral model to the machine.

12. The system of claim 11, wherein the system is further configured to:
generate, based on the analysis of the plurality of sensory inputs associated with the machine, at least one adaptive threshold for the at least one normal behavior pattern.

13. The system of claim 11, wherein the system is further configured to:
query at least one database for machine behavioral models, wherein each selected machine behavioral model is among a plurality of machine behavioral models returned with respect to the query.

14. The system of claim 11, wherein the system is further configured to:
cluster at least two of the selected at least one machine behavioral model.

15. The system of claim 14, wherein the system is further configured to:
extract, from the plurality of sensory inputs, at least one optimal parameter for each selected machine behavioral model; and
calibrate each selected machine behavioral model based on the at least one optimal parameter extracted for the selected machine behavioral model.

16. The system of claim 15, wherein the system is further configured to:
apply, for the selected behavioral model, a set of heuristics to the plurality of sensory inputs to determine the at least one optimal parameter for the selected machine behavioral model.

17. The system of claim 15, wherein the system is further configured to:
determine, for each portion of the machine, at least one representative model of the calibrated at least one machine behavioral model, wherein the clustered at least two machine behavioral models includes each determined representative model.

18. The system of claim 11, wherein allocating the generated optimal machine behavioral model further comprises sending the generated optimal machine behavioral model to a machine monitoring system, wherein the machine monitoring system monitors behavior of the machine via unsupervised machine learning using the allocated model.

19. The system of claim 11, wherein the system is further configured to:
preprocess the plurality of sensory inputs, wherein the preprocessing includes extracting at least one feature from raw sensory data.
